(19) United States
(12) Patent Application Publication
(10) Pub. No.: US 2014/0153751 A1
(43) Pub. Date: Jun. 5, 2014

(54) AUDIO CONTROL BASED ON ORIENTATION

(71) Applicant: Kevin C. Wells, Portland, OR (US)

(72) Inventor: Kevin C. Wells, Portland, OR (US)

(21) Appl. No.: 13/997,423

(22) PCT Filed: Mar. 29, 2012
(86) PCT No.: PCT/US12/31188

§ 371 Date: Oct. 25, 2013

(51) Int. Cl. H04S 7/00

(52) U.S. Cl. CPC H04S 7/304
USPC 381/303; 381/74

(57) ABSTRACT

A device may be configured to sense its own orientation with respect to a coordinate system, and to also sense the orientation of a user's head with respect to the device. The device may then determine whether the device orientation has changed with respect to the coordinate system and/or whether the head orientation has changed with respect to the device. Audio signal generation in the device may then be controlled based on the determination. For example, the position of a simulated sound source may be changed in a 3-D audio field based on determined changes in device and/or head orientation. The audio signal may then be transmitted from the device to an apparatus configured to generate sound based on the audio signal (e.g., headphones).

### BACKGROUND

Three-Dimensional (3-D) audio is a technology in which sound is generated in a manner that creates the illusion that the source of the sound is somewhere in a 3-D space surrounding the hearer. For example, movies and video games may employ 3-D audio to create an “immersive” effect wherein the participant (e.g., user) is made to feel as if actually a part of the content being viewed by generating sound that appears to come from various directions (e.g., left, center right, back, etc.). In stationary systems this effect may be simulated through the placement of speakers in the various directions. Sound from content such as, for example, a movie, a video game, etc. may then be directed to a speaker corresponding to the direction from which the sound is meant to be heard. Since the system is fixed, the sound always appears to be coming from the correct direction (e.g., the direction intended by the creator of the content) regardless of where the user is positioned. More recently, portable systems (e.g., mobile communication and/or computing devices) have evolved to have the capability of generating 3-D audio. A user may view content on a portable system and listen to audio associated with the content on headphones configured to generate directional sound in accordance with the content. However, at least one limitation that exists in portable 3-D audio is that the sound field is relative to the headphones. As opposed to a stationary system where the sound generation is relative to a fixed coordinate system, and so the user is free to move about the physical space without changing the intended sense of immersion, in portable devices the coordinate system is relative to the headphones of the user, and thus, the head of the user. When the head of the user moves the sound field moves as well. As a result, the direction from which a sound emanates no longer matches the direction intended by the creation of the content, destroying the intended sense of immersion to be created by the content.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system configured for audio control based on orientation in accordance with at least one embodiment of the present disclosure;

FIG. 2 illustrates an example device usable with at least one embodiment of the present disclosure;

FIG. 3 illustrates example interaction between audio control circuitry and other circuitry in a device in accordance with at least one embodiment of the present disclosure;

FIG. 4 illustrates an example initial aligned orientation in accordance with at least one embodiment of the present disclosure;

FIG. 5 illustrates an example of a displaced orientation in accordance with at least one embodiment of the present disclosure;

FIG. 6 illustrates a second example of a displaced orientation in accordance with at least one embodiment of the present disclosure; and

FIG. 7 is a flowchart of example operations for audio control based on orientation in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

Generally, this disclosure describes systems and methods for audio control based on orientation. “Audio” or “audio signal,” as referred to herein, comprises three-dimensional (3-D) audio that is configured to simulate sound sources at various locations within a 3-D sound field so that the listener (e.g., user) perceives that he/she is immersed in the content corresponding to the audio. Any 3-D currently known or later emerging audio technology (e.g., DirectSound® from Microsoft Corp., open AL® from Creative Technology Ltd., etc.) may be employed as the various embodiments disclosed herein to automatically manipulate 3-D audio configuration, not the manner in which 3-D is produced. In one embodiment, audio signal generation in a device may be controlled to maintain the perceived location of a sound source constant with respect to coordinate system, regardless of changes of position with respect to the device and/or user. A coordinate system, as referred to herein, may be a fixed coordinate system such as, for example, the World Geodetic System (WGS), longitude/latitude, compass directions (North (N), East (E), South (S) and West (W)), etc. Audio signal generation may be controlled based on the orientation of a device with respect to a coordinate system and/or a head of the user with respect to the device. Orientation, as referred to herein, may include both the locations of the device/head in the coordinate system and a relative position (e.g., angle, tilt, offset, etc.) of the device with respect to the coordinate system, and the head with respect to the device. For example, a device configured to generate audio that is, for example, associated with video content such as a movie, game, etc. being played on the device may determine its orientation with respect to a fixed coordinate system. In addition, the device may further determine the orientation of a user's head with respect to the device. The device may then determine if the orientation of the device has changed with respect to the fixed coordinate system and/or if the orientation of the user's head has changed with respect to the device. Audio signal generation may then be controlled in the device (e.g., simulated positions of sound sources in the 3-D sound field relative to the user's headphones may be changed) to maintain the position of the sound sources perceived by the user with respect to the coordinate system. Thus, the sense of immersion intended by the content creator is maintained regardless of device/head movement.

In one embodiment, the device orientation with respect to the coordinate system may be determined based on, for example, coordinate information obtained from a Global Positioning System (GPS) receiver in the device, position information determined based on a wireless link to an access point (AP), direction information obtained from an electronic compass in the device, orientation information provided by orientation sensors, motion information provided by motion sensors, acceleration sensors, etc. In the same or a different embodiment, the head orientation with respect to the device may be determined based on detection of the user's face or detection of a position corresponding to an apparatus worn by the user. In user face detection the device may capture an image, detect a head within the image, determine a face in the detected head, and may determine the orientation of the user's head based on the detected face. In worn apparatus (e.g., headphones or another apparatus worn by the user), the device may receive a signal from the worn apparatus indicating the orientation of the worn apparatus, and orientation of the user's head may be determined based on the orientation of the worn apparatus. For example, the worn apparatus may provide location information to the apparatus via wireless communication, the worn apparatus may transmit a wireless signal that the device may use to determine orientation for the worn apparatus, etc. The device may then determine if the device orientation has changed with respect to the coordinate system from the last time device orientation was determined and/or if the head orientation has changed with respect to the device from the last time head orientation was determined. If changes are determined to have occurred, at least one setting may be changed in the audio signal generation configuration within the device in order to maintain the perceived locations of the simulated sound sources constant with respect to the coordinate system.

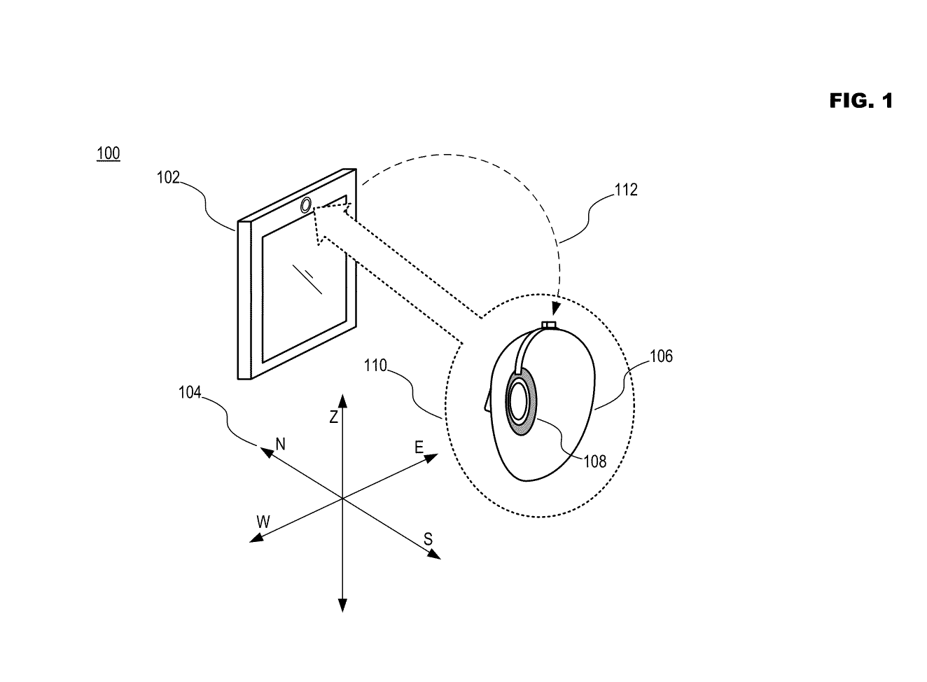

FIG. 1 illustrates example system 100 configured for audio control based on orientation in accordance with at least one embodiment of the present disclosure. System 100 may include a device 102 configured to generate audio (e.g., a 3-D audio signal). Examples of system 100 may include a mobile communication device such as cellular handset or a smartphone based on the Android® operating system (OS), iOS®, Blackberry® OS, Palm® OS, Symbian® OS, etc., a mobile computing device such as a tablet computer like an ipad®, Galaxy Tab®, Kindle Fire®, etc., an Ultrabook® including a low-power chipset manufactured by Intel Corp., a netbook, a notebook computer, a laptop computer, etc. Examples of device 102 may also include typically stationary devices when used in conjunction with headphones or another listening apparatus that allows for user mobility. Stationary systems may include a desktop computer with an integrated or separate display, a standalone monitor (e.g., television) and/or systems that may comprise a standalone monitor such as a home entertainment system, a videoconferencing system, etc.

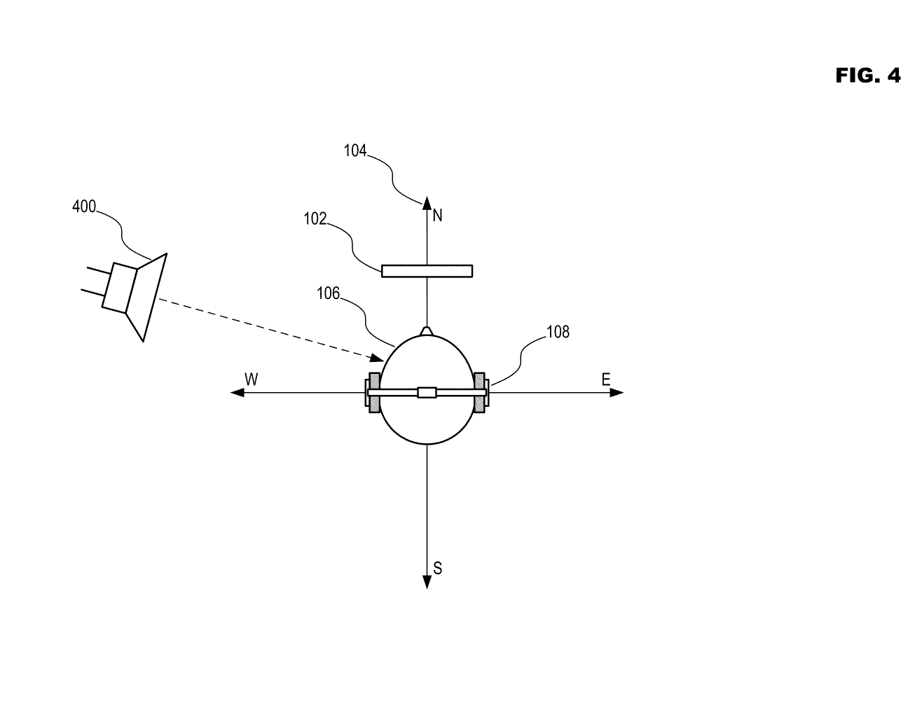

The orientation of device 102 may be determined with respect to coordinate system 104. As indicated above, coordinate system 104 may be fixed with respect to the physical location in which system 100 is operating. The orientation of device 102 and/or a user's head 106 may be determined with respect to coordinate system 104 in order to lock the sound field generated by device 102 into a fixed perspective that does not vary with the motion of device 102 and/or head 106. As discussed above, orientations in coordinate system 104 may be determined based on the type of technology being employed by device 102, which will be discussed in further detail in regard to FIG. 4. A user that is, for example, viewing video content on device 102 may listen to an audio signal generated in association with the content on headphones 108. Headphones 108 may include any apparatus configured to generate sound based on an audio signal that may be worn by a user, and may include various configurations such as over-the-ear headphones, in-ear headphones (e.g., ear buds), headphones integrated into other devices (e.g., headphones that are part of a content viewing apparatus worn by a user), etc. In one embodiment, headphones 108 may be specially equipped to generate a 3-D sound field based on based on a 3-D audio signal (e.g., headphones 108 may include multiple speaker drivers, specially placed speaker drivers, etc. Device 102 may be configured to determine the orientation of head 106 as shown at 110, and may then generate audio signal 112 based on the determined orientation of device 102 with respect to coordinate system 104 and/or the orientation of head 106 with respect to device 102. Audio signal 112 may be transmitted to headphones 106 via wired or wireless communication.

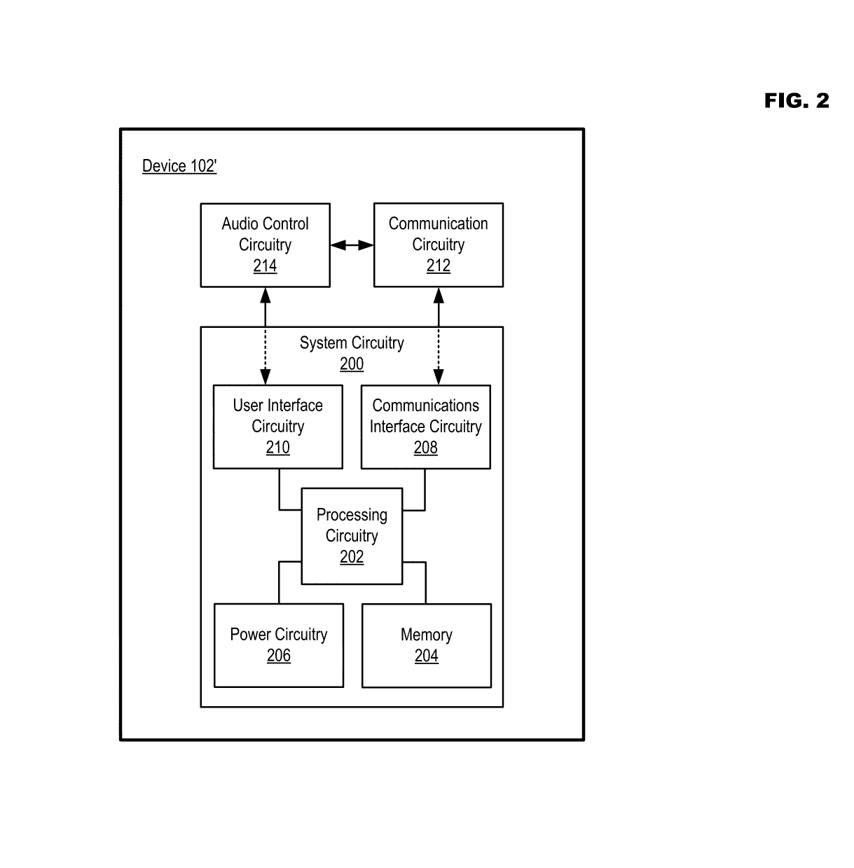

FIG. 2 illustrates example device 102′ usable with at least one embodiment of the present disclosure. Device 102′ comprises circuitry capable of implementing the functionality illustrated in FIG. 1. System circuitry 200 may be configured to perform various functions that may occur during normal operation of device 102′. For example, processing circuitry 202 may comprise one or more processors situated in separate components, or alternatively, may comprise one or more processing cores situated in a single component (e.g., in a System-on-a-Chip (SOC) configuration). Example processors may include various X86-based microprocessors available from the Intel Corporation including those in the Pentium, Xeon, Itanium, Celeron, Atom, Core i-series product families. Processing circuitry 202 may be configured to execute instructions in device 102′. Instructions may include program code configured to cause processing circuitry 202 to perform activities related to reading data, writing data, processing data, formulating data, converting data, transforming data, etc. Instructions, data, etc. may be stored in memory 204. Memory 204 may comprise random access memory (RAM) or read-only memory (ROM) in a fixed or removable format. RAM may include memory configured to hold information during the operation of device 102′ such as, for example, static RAM (SRAM) or Dynamic RAM (DRAM). ROM may include memories such as bios memory configured to provide instructions when device 102′ activates, programmable memories such as electronic programmable ROMs, (EPROMS), Flash, etc. Other fixed and/or removable memory may include magnetic memories such as floppy disks, hard drives, etc., electronic memories such as solid state flash memory (e.g., eMMC, etc.), removable memory cards or sticks (e.g., uSD, USB, etc.), optical memories such as compact disc-based ROM (CD-ROM), etc. Power Circuitry 206 may include internal (e.g., battery) and/or external (e.g., wall plug) power sources and circuitry configured to supply device 102′ with the power needed to operate. Communications interface circuitry 208 may be configured to handle packet routing and various control functions for communication circuitry 212, which may include various resources for conducting wired and/or wireless communications. Wired communications may include mediums such as, for example, Universal Serial Bus (USB), Ethernet, etc. Wireless communications may include, for example, close-proximity wireless mediums (e.g., radio frequency (RF), infrared (IR), etc.), short-range wireless mediums (e.g., Bluetooth, wireless local area networking (WLAN), etc.) and long range wireless mediums (e.g., cellular, satellite, etc.). For example, communications interface circuitry 208 may be configured to prevent wireless communications active in communication circuitry 212 from interfering with each other. In performing this function, communications interface circuitry 208 may schedule activities for communication circuitry 212 based on the relative priority of the pending messages.

User interface circuitry 210 may include circuitry configured to allow a user to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, indicators, electromechanical components for vibration, motion, etc.). In one embodiment, user interface circuitry 210 may include, or may be coupled to, audio control circuitry 214. Audio control circuitry 214 may be configured to receive orientation information for device 102′ and/or head 106 from user interface circuitry 214 or other circuitry in device 102′, to determine if the orientation of the device 102′ has changed with respect to coordinate system 104 and/or if the orientation of head 106 has changed with respect to device 102′, and to control generation of the audio signal based on the determination. The audio signal may then be output from device 102′ via, for example, communication circuitry 212 in instances where wireless communication (e.g., Bluetooth) is employed to transmit the audio signal to headphones 108.

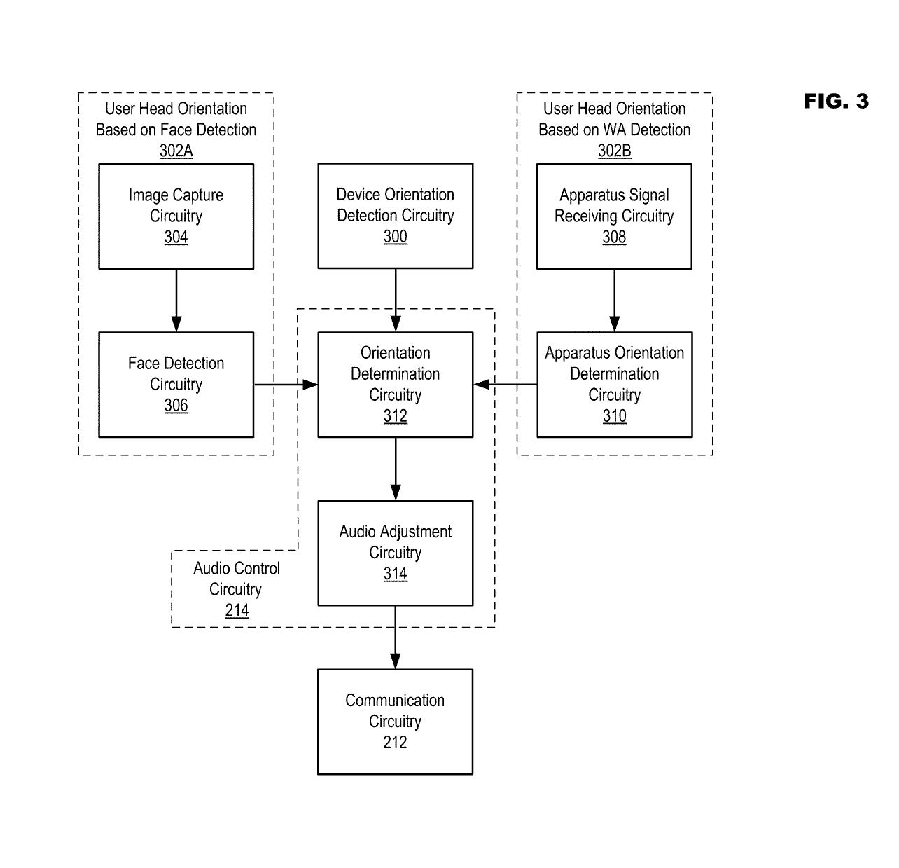

FIG. 3 illustrates an example interaction between audio control circuitry 214 and other circuitry in device 102 in accordance with at least one embodiment of the present disclosure. Audio control circuitry 214 may receive device orientation information from device orientation detection circuitry 300. Device orientation detection circuitry 300 may be configured to provide position and/or orientation information for device 102 with respect to coordinate system 104 such as, for example, GPS receiver circuitry configured to provide position/orientation information, compass circuitry configured to provide orientation information with regard to magnetic direction (e.g., in terms of degrees from true North or magnetic North), short-range wireless communication circuitry configured to provide relative or absolute position/orientation information, etc. For the short-range wireless communication scenario, device 102 may be coupled to another device via short-range wireless communication (e.g., to an access point (AP) via WLAN communication) and may be able to determine relative position and/or orientation based on the strength and/or direction of signals received from the AP. Absolute position may then be determined based on the location of the AP. Device orientation circuitry 300 may also determine the orientation of device 102 based on various sensors not tied to coordinate system 104 such as, for example, orientation sensors (e.g., tilt/angle sensors, etc.), motion sensors, acceleration sensors, etc.

Audio control circuitry 214 may also receive head orientation information using a variety of techniques, examples of which are illustrated at 302A and 302B. The example illustrated at 302 determines head orientation based on face detection. In this regard, image capture circuitry (e.g., a camera in user interface circuitry 210) may be configured to capture images periodically, on a set interval, etc. Face detection circuitry 306 may be configured to identify a face and/or facial region in the images provided by image capture circuitry 304, and in turn, an orientation for head 106. For example, face detection circuitry 306 may include custom, proprietary, known and/or after-developed face recognition code (or instruction sets), hardware, and/or firmware that are generally well-defined and operable to receive an image (e.g., but not limited to, a RGB color image) and to identify, at least to a certain extent, a face in the image. Face detection circuitry 306 may also be configured to track the face through a series of images (e.g., video frames at 24 frames per second). Detection systems usable by face detection circuitry 306 include particle filtering, mean shift, Kalman filtering, etc., each of which may utilize edge analysis, sum-of-square-difference analysis, feature point analysis, histogram analysis, skin tone analysis, etc.

In the embodiment illustrated at 302B, the orientation of head 106 may be determined based on an apparatus worn by the user (e.g., worn apparatus or WA) that is in communication with apparatus 102. An example of an apparatus worn by the user is headphones 108 or a visual aid apparatus used to view 3-D video content (e.g., glasses, goggles, etc.), but may also include apparatuses specifically designed to provide head orientation information (e.g., a sensor affixed to a headband, etc.). In one embodiment, a position/orientation sensor and transmitter may be affixed to headphones 108 and apparatus signal receiving circuitry 308 may be configured to receive information from the sensor. The information may then be provided to apparatus orientation determination circuitry 310, which may be configured to determine orientation of the apparatus based on the information. Since headphones 108 are attached to head 106 in a fixed orientation, the orientation of head 106 may be derived from the orientation of headphones 108. In another implementation, a transmitter in headphones 108 may continually transmit a beacon signal (e.g., a signal that is identifiable as being transmitted by headphones 108) that is received by apparatus position receiving circuitry 308. Apparatus orientation determination circuitry 310 may then determine the orientation of headphones 108 based on characteristics of the received signal (e.g., a direction from which the signal was received, received signal strength, etc.).

Orientation determination circuitry 312 may receive device orientation information from device orientation detection circuitry 300, and may receive head orientation information via one of the example techniques illustrated at 302A and 302B. Orientation determination circuitry 312 may then be configured to determine if the orientation of device 102 has changed with respect to coordinate system 104 and/or the orientation of head 106 has changed with respect to device 102. Orientation change may be quantified by, for example, angle offset from the previous orientation measurement, distance offset from the previous orientation measurement, etc. Sensed changes in orientation may be provided to audio adjustment circuitry 314, which may be configured to alter the generation of the audio signal based on the change in orientation. The manner in which the generation is altered may depend on, for example, the particular 3-D audio technology being employed. For example, many 3-D audio systems allow the location of simulated sound sources to be modified in the 3-D audio field (e.g., via the configuration of certain software parameters in the 3-D audio control software). In one embodiment, any changes in orientation determined by orientation determination circuitry 306 may be used to offset the simulated position of sound sources in the 3-D audio field so that the simulated sound sources appear fixed to coordinate system 104 regardless of the position of device 102 or head 106. The resulting audio signal may then be transmitted from device 102 (e.g., to headphones 108) via communication circuitry 212.

FIG. 4 illustrates an example initial aligned orientation in accordance with at least one embodiment of the present disclosure. In particular, head 106 is aligned with device 102 along coordinate system 104, which in the example of FIG. 4 is based on magnetic compass headings (e.g., N, E, S and W). Simulated sound source 400 does not actually exist, but is perceived by the user as producing sound from a NW direction, and may correspond to, for example, sound sources to the left of the user as depicted in content being viewed on device 102 (e.g., a movie, video game, etc.). Simulated sound source 400 may be generated by headphones 108 using an audio signal generated by device 102 and then transmitted to headphones 108.

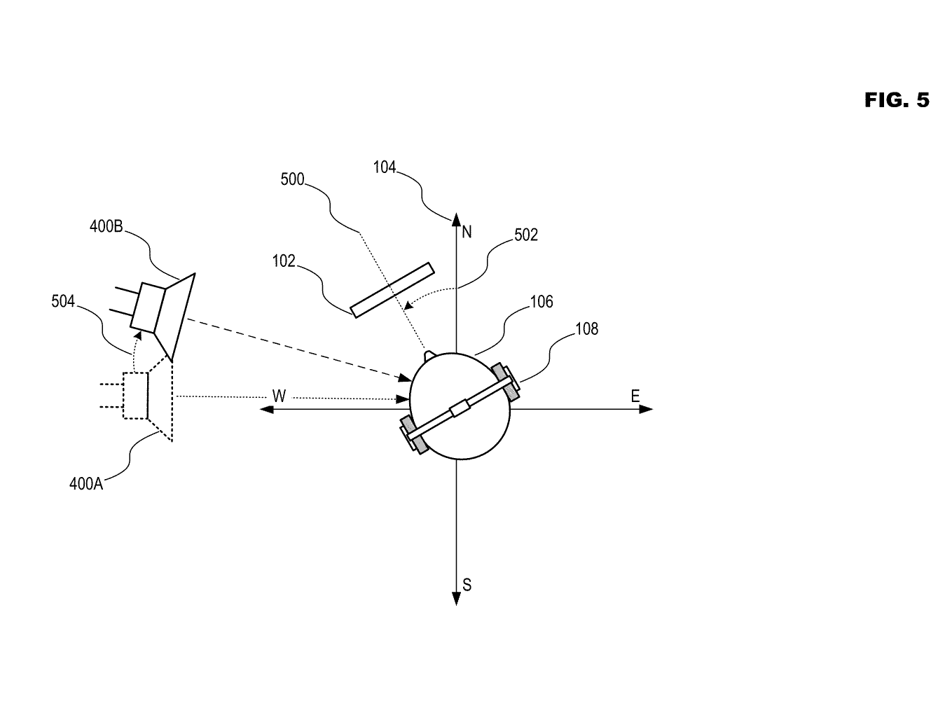

FIG. 5 illustrates an example of a displaced orientation in accordance with at least one embodiment of the present disclosure. In particular, device 102 and head 106 are still aligned along axis 500, but device 102 is no longer aligned with “N” (North) in coordinate system 104. It is important to note that without audio control such as disclosed herein, the sound generated by headphones 108 stays relative to the position of headphones 108. Therefore, when device 102 is offset as shown at 502, head 106 and headphones 108 are also displaced a proportional amount, and the perceived position of the simulated sound source shifts to 400A. The displaced position of simulated sound source 400A no longer matches the position for simulated sound source 400 in coordinate system 104 as intended by the content creator, which may disrupt the sense of 3-D immersion for the user. In one embodiment, device 102 may determine that its orientation with respect to coordinate system 104 has been displaced by offset 502, and may change the position of the simulated sound source to 400B as shown at 504. As a result, the sound coming from sound source 400B shifts from the perspective of the user (e.g., the sound seems to be coming from closer to the front of head 106), while remaining in alignment with coordinate system 104.

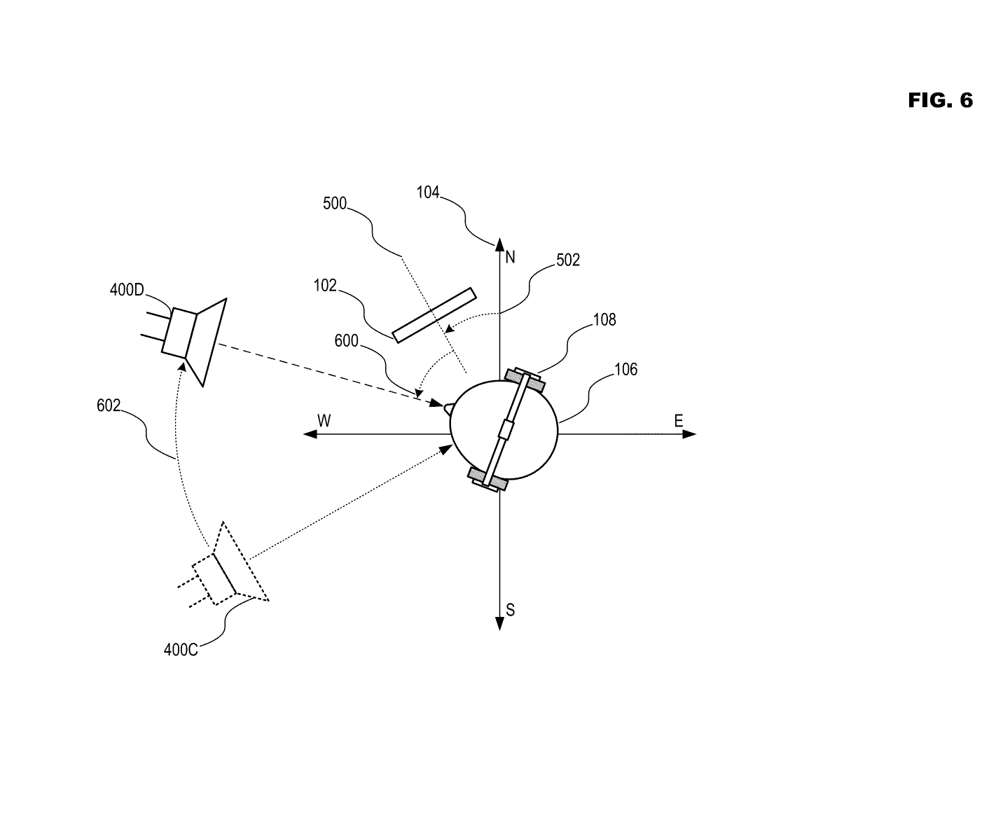

FIG. 6 illustrates a second example of a displaced orientation in accordance with at least one embodiment of the present disclosure. In addition to device 102 being displaced from “N” in coordinate system 104 by offset 502, head 106 is further displaced from axis 500 by offset 600. Similar to the example of FIG. 5, without audio control such as disclosed herein, displacement 600 would cause the perceived location of simulated sound source to shift to 400C in FIG. 500. Instead, in one embodiment of the present invention both the displacement of device 102 from coordinate system 104 (e.g., offset 502) and the displacement from head 106 to device 102 (e.g., offset 600) may be determined, and the generation of the audio signal may be controlled so that the perceived position of the simulated sound source is shifted to 400D as illustrated at 602. The sound from simulated sound source 400D now seems to be coming from directly in front of head 106. Thus, while device 102 and/or head 106 may move with respect to coordinate system 104, the perceived location of simulated sound source 400 remains tied to coordinate system 104, and thus, the sense of 3-D immersion intended by the creator of the content may be preserved.

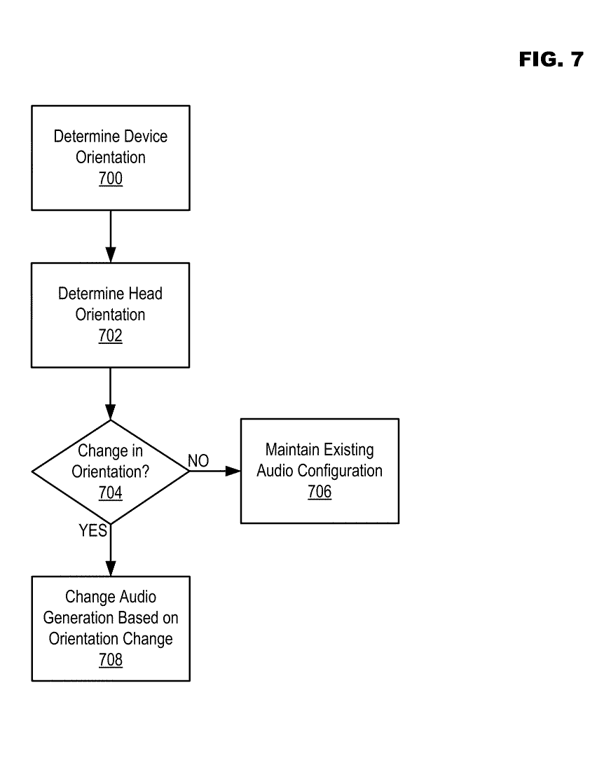

FIG. 7 is a flowchart of example operations for audio control based on orientation in accordance with at least one embodiment of the present disclosure. In operation 700 device orientation may be determined. For example, current device orientation may be detected and a determination may be made as to whether the orientation of the device configured to generate an audio signal has changed with respect to a fixed coordinate system. Head orientation may then be determined in operation 702. For example, current user head orientation may be detected and a determination may be made as to whether the orientation of the user's head has changed with respect to the device. A determination may then be made in operation 704 as to whether there has been a change in orientation (e.g., the device with respect to the coordinate system and/or the head with respect to the device). If it is determined in operation 704 that there was no change in orientation, then in operation 706 the device may maintain the existing audio configuration. Alternatively, if it is determined that an orientation change has occurred, then in operation 708 the device may control audio generation based on the orientation change. For example, the device may reconfigure audio parameters based on the orientation change in order to change the position of a simulated sound source in the 3-D audio field. As a result, the perceived position of the simulated sound source may remain constant with respect to the coordinate system regardless of changes in device or head orientation.

While FIG. 7 illustrates various operations according to an embodiment, it is to be understood that not all of the operations depicted in FIG. 7 are necessary for other embodiments. Indeed, it is fully contemplated herein that in other embodiments of the present disclosure, the operations depicted in FIG. 7, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations.

Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure provides systems and methods for audio control based on orientation. A device may be configured to sense its own orientation with respect to a coordinate system, and to also sense the orientation of a user's head with respect to the device. The device may then determine whether the device orientation has changed with respect to the coordinate system and/or whether the head orientation has changed with respect to the device. Audio signal generation in the device may then be controlled based on the determination. For example, the position of a simulated sound source may be changed in a 3-D audio field based on determined changes in device and/or head orientation. The audio signal may then be transmitted from the device to an apparatus configured to generate sound based on the audio signal (e.g., headphones).

The following examples pertain to further embodiments. In one example embodiment there is provided a device. The device may include device orientation detection circuitry configured to determine device orientation with respect to a coordinate system, user head orientation detection circuitry configured to determine user head orientation with respect to the device and audio adjustment circuitry configured to control the generation of an audio signal based on the device orientation and user head orientation.

The above example device may be further configured, wherein the device further comprises image capture circuitry and determining the user head orientation with respect to the device comprises capturing an image using the image capture circuitry, detecting a face of a user in the image and determining an orientation for the head of the user based on the detected user face.

The above example device may be further configured, wherein determining the user head orientation with respect to the device comprises detecting an orientation of an apparatus worn by a user and determining the user head orientation based on the orientation of the worn apparatus. In this example configuration the device may further comprise at least a wireless receiver and detecting the worn apparatus orientation comprises receiving position information from the worn apparatus via wireless communication.

The above example device may be further configured, wherein controlling the generation of the audio signal is based on the relative orientation of the device with respect to the coordinate system or the relative orientation of the user head with respect to the device.

The above example device may be further configured, wherein controlling the generation of the audio signal is based on the relative orientation of the device with respect to the coordinate system and the relative orientation of the user head with respect to the device.

The above example device may be further configured, wherein the audio signal is a surround sound audio signal configured to simulate a three-dimensional (3-D) sound field. In this example configuration controlling the generation of the audio signal may comprise changing the location of a simulated sound source within the 3-D sound field. In this example configuration changing the location of the simulated sound source within the 3-D sound field may further comprise changing the location of the simulated sound source to maintain the relative position of the simulated source within the coordinate system with respect to at least the user head orientation.

The above example device may be further configured, wherein the device further comprises at least a wireless transmitter configured to transmit the audio signal.

In another example embodiment there is provided a method. The method may comprise determining device orientation with respect to a coordinate system, determining user head orientation with respect to the device and controlling generation of an audio signal based on the device orientation and user head orientation.

The above example method may be further configured, wherein determining the user head orientation with respect to the device comprises capturing an image, detecting a face of a user in the image and determining an orientation for the head of the user based on the detected user face.

The above example method may be further configured, wherein determining the user head orientation with respect to the device comprises detecting an orientation of an apparatus worn by a user and determining the user head orientation based on the orientation of the worn apparatus. In this example configuration detecting the worn apparatus orientation may further comprise receiving position information from the worn apparatus via wireless communication.

The above example method may be further configured, wherein controlling the generation of the audio signal is based on the relative orientation of the device with respect to the coordinate system or the relative orientation of the user head with respect to the device.

The above example method may be further configured, wherein controlling the generation of the audio signal is based on the relative orientation of the device with respect to the coordinate system and the relative orientation of the user head with respect to the device.

The above example method may be further configured, wherein the audio signal is a surround sound audio signal configured to simulate a three-dimensional (3-D) sound field. In this example configuration controlling the generation of the audio signal may further comprise changing the location of a simulated sound source within the 3-D sound field. In this example configuration changing the location of the simulated sound source within the 3-D sound field may further comprise changing the location of the simulated sound source to maintain the relative position of the simulated source within the coordinate system with respect to at least the user head orientation.

The above example method may further comprise transmitting the audio signal via wireless communication.

In another example embodiment there is provided a system comprising at least a device configured to generate an audio signal, the system being arranged to perform any of the above example methods.

In another example embodiment there is provided a chipset arranged to perform any of the above example methods.

In another example embodiment there is provided at least one machine readable medium comprising a plurality of instructions that, in response to be being executed on a computing device, cause the computing device to carry out any of the above example methods.

In another example embodiment there is provided an apparatus for audio control based on orientation, the apparatus being arranged to perform any of the above example methods.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-24. (canceled)

25. A device, comprising:
device orientation detection circuitry configured to determine device orientation with respect to a coordinate system;
user head orientation detection circuitry configured to determine user head orientation with respect to the device; and
audio adjustment circuitry configured to control the generation of an audio signal based on the device orientation and user head orientation.

26. The device of claim 25, wherein the device further comprises image capture circuitry and determining the user head orientation with respect to the device comprises capturing an image using the image capture circuitry, detecting a face of a user in the image and determining an orientation for the head of the user based on the detected user face.

27. The device of claim 25, wherein determining the user head orientation with respect to the device comprises detecting an orientation of an apparatus worn by a user and determining the user head orientation based on the orientation of the worn apparatus.

28. The device of claim 27, wherein the device further comprises at least a wireless receiver and detecting the worn apparatus orientation comprises receiving position information from the worn apparatus via wireless communication.

29. The device of claim 25, wherein controlling the generation of the audio signal is based on the relative orientation of the device with respect to the coordinate system or the relative orientation of the user head with respect to the device.

30. The device of claim 25, wherein controlling the generation of the audio signal is based on the relative orientation of the device with respect to the coordinate system and the relative orientation of the user head with respect to the device.

31. The device of claim 25, wherein the audio signal is a surround sound audio signal configured to simulate a three-dimensional (3-D) sound field.

32. The device of claim 31, wherein controlling the generation of the audio signal comprises changing the location of a simulated sound source within the 3-D sound field.

33. The device of claim 32, wherein changing the location of the simulated sound source within the 3-D sound field comprises changing the location of the simulated sound source to maintain the relative position of the simulated source within the coordinate system with respect to at least the user head orientation.

34. The device of claim 25, wherein the device further comprises at least a wireless transmitter configured to transmit the audio signal.

35. A method, comprising:
determining device orientation with respect to a coordinate system;
determining user head orientation with respect to the device; and
controlling generation of an audio signal based on the device orientation and user head orientation.

36. The method of claim 35, wherein determining the user head orientation with respect to the device comprises capturing an image, detecting a face of a user in the image and determining an orientation for the head of the user based on the detected user face.

37. The method of claim 35, wherein determining the user head orientation with respect to the device comprises detecting an orientation of an apparatus worn by a user and determining the user head orientation based on the orientation of the worn apparatus.

38. The method of claim 37, wherein detecting the worn apparatus orientation comprises receiving position information from the worn apparatus via wireless communication.

39. The method of claim 35, wherein controlling the generation of the audio signal is based on the relative orientation of the device with respect to the coordinate system or the relative orientation of the user head with respect to the device.

40. The method of claim 35, wherein controlling the generation of the audio signal is based on the relative orientation of the device with respect to the coordinate system and the relative orientation of the user head with respect to the device.

41. The method of claim 35, wherein the audio signal is a surround sound audio signal configured to simulate a three-dimensional (3-D) sound field.

42. The method of claim 41, wherein controlling the generation of the audio signal comprises changing the location of a simulated sound source within the 3-D sound field.

43. The method of claim 42, wherein changing the location of the simulated sound source within the 3-D sound field comprises changing the location of the simulated sound source to maintain the relative position of the simulated source within the coordinate system with respect to at least the user head orientation.

44. The method of claim 11, further comprising transmitting the audio signal via wireless communication.

45. A system comprising at least one machine-readable storage medium having stored thereon, individually or in combination, instructions that when executed by one or more processors result in the following operations comprising:
determining device orientation with respect to a coordinate system;
determining user head orientation with respect to the device; and
controlling generation of an audio signal based on the device orientation and user head orientation.

46. The system of claim 45, wherein determining the user head orientation with respect to the device comprises capturing an image, detecting a face of a user in the image and determining an orientation for the head of the user based on the detected user face.

47. The system of claim 45, wherein determining the user head orientation with respect to the device comprises detecting an orientation of an apparatus worn by a user and determining the user head orientation based on the orientation of the worn apparatus.

48. The system of claim 47, wherein detecting the worn apparatus orientation comprises receiving position information from the worn apparatus via wireless communication.

49. The system of claim 45, wherein controlling the generation of the audio signal is based on the relative orientation of the device with respect to the coordinate system or the relative orientation of the user head with respect to the device.

50. The system of claim 45, wherein controlling the generation of the audio signal is based on the relative orientation of the device with respect to the coordinate system and the relative orientation of the user head with respect to the device.

51. The system of claim 45, wherein the audio signal is a surround sound audio signal configured to simulate a three-dimensional (3-D) sound field.

52. The system of claim 51, wherein controlling the generation of the audio signal comprises changing the location of a simulated sound source within the 3-D sound field.

53. The system of claim 52, wherein changing the location of the simulated sound source within the 3-D sound field comprises changing the location of the simulated sound source to maintain the relative position of the simulated source within the coordinate system with respect to at least the user head orientation.

54. The system of claim 45, further comprising transmitting the audio signal via wireless communication.
